(19) United States
(12) Patent Application Publication
(10) Pub. No.: US 2009/0253556 A1
(43) Pub. Date: Oct. 8, 2009

(54) EXERCISE MAT

(76) Inventor: Joseph Chaplik, Portland, OR (US)

Correspondence Address: DAVIS WRIGHT TREMAINE LLP/Los Angeles, 865 FIGUEROA STREET, SUITE 2400, LOS ANGELES, CA, 90017-2566, US

(21) Appl. No.: 12/061,534

(22) Filed: Apr. 2, 2008

(51) Int. Cl. B32B 5/22

(52) U.S. Cl. 482/23

(57) ABSTRACT

This invention relates to an exercise mat that provides reference points and orientation for exercises. In one embodiment, the present invention provides an exercise mat for ensuring exercises are performed properly by providing a series of markings and/or notations. In another embodiment, the invention provides a method of performing an exercise by describing physical movements in conjunction with markings.

### FIELD OF THE INVENTION

The invention relates to the field of exercise mats and exercise instruction. Preferred aspects of the invention employ an exercise mat with markings for hand and/or foot placement.

### BACKGROUND

As known in the art, a typical exercise mat is shaped flat, often made of a soft rubbery material. The exercise mat is conventionally used in conjunction with exercises by serving as a cushion for a person performing exercises directly on top of the mat.

Although the mat primarily serves to provide physical support for a person performing an exercise directly on top of it, there is a lack of reference and orientation for the person performing the exercise. Without points of reference, a person exercising often has difficulty ensuring that he or she is performing the exercise properly. Similarly, exercise instructions that could be given, for example from a book or video, could only refer vaguely to exercise positions due to the lack of reference. A means of providing points of reference and orientation for an exercise would be advantageous for exercises in general.

Thus, there is a need in the art for a mat that could provide points of reference and orientation for exercises.

### SUMMARY OF THE INVENTION

Various embodiments provide an exercise mat, comprising a front side, and a back side, where the front side comprises a plurality of hand placement markings and instructions, and where the instructions describe an exercise selected from the group consisting of push ups, crunches and cross-knee twisting crunches. In other embodiments, the back side comprises a sitting placement marking. In other embodiments, the back side comprises a foot placement marking. In other embodiments, the front side comprises a vertical axis oriented down its center and six pairs of hand placement markings, where the vertical axis divides each pair of the six pairs of hand placement markings such that the markings in a pair are on opposite sides of the vertical axis and each marking in a pair is located at an equal distance from the axis. In another embodiment, at least one pair of the six pairs of hand placement markings are oval in shape and the longest oval axis is at an angle of 90° in relation to the vertical axis. In another embodiment, the front side comprises a torso placement marking.

Other embodiments provide an exercise mat, comprising a flat surface having a vertical axis oriented down its center, a first pair of hand placement markings located at a first position along the vertical axis and separated from one another by a first distance, a second pair of hand placement markings located at a second position along the vertical axis and separated from one another by a second distance, and a third pair of hand placement markings at a third position along the vertical axis and separated from one another by a third distance, where the first distance is less than the second distance and the third distance, and the second distance is less than the third distance. In other embodiments, the first distance is between 6 and 10 inches. In other embodiments, the second distance is between 11 and 17 inches. In other embodiments, the third distance is between 18 and 25 inches. In other embodiments, the second position is located between the first position and the third position. In other embodiments, the exercise mat may further comprise a fourth pair of hand placement markings located at a fourth position along the vertical axis and separated from one another by a fourth distance, where the fourth distance is less than the first distance, second distance and third distance. In other embodiments, the fourth position is located between the first position and the second position. In other embodiments, the exercise mat may also further comprise a fifth pair of hand placement markings located at a fifth position along the vertical axis and separated from one another by a fifth distance, where the fifth distance is greater than the first distance, second distance, third distance and fourth distance. In other embodiments, the exercise mat further comprises a sixth pair of hand placement markings located at a sixth position long the vertical axis and separated from one another by a sixth distance, wherein the sixth distance is greater than the fifth distance. In other embodiments, the exercise mat further comprises instructions for performing exercises selected from the group consisting of push ups, crunches and cross-knee twisting crunches, wherein the instructions appear on the flat surface.

Various embodiments may provide methods of utilizing an exercise mat, comprising obtaining an exercise mat comprising a flat surface having a vertical axis oriented down its center, a first pair of hand placement markings located at a first position along the vertical axis and separated from one another by a first distance, a second pair of hand placement markings located at a second position along the vertical axis and separated from one another by a second distance, and a third pair of hand placement markings at a third position along the vertical axis and separated from one another by a third distance, where the first distance is less than the second distance and the third distance, and the second distance is less than the third distance, and utilizing the exercise mat by following an exercise regimen, where, in response to instructions, a user places hands on the hand placement markings. In another embodiment, the exercise regimen is described as text on the exercise mat.

Other features and advantages of the invention will become apparent from the following detailed description, taken in conjunction with the accompanying drawings, which illustrate, by way of example, various embodiments of the invention.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 depicts a front view of the exercise mat in accordance with an embodiment of the present invention. The various placement markings can be used for performing a variety of push-up exercises at various levels of difficulty and positions. Instructions for performing these exercises in conjunction with the placement markings can be provided as text on the mat.

FIG. 2 depicts a back view of the exercise mat in accordance with an embodiment of the present invention. The oval shape is an example of a placement marking which could designate where a person sits. Alternatively, the placement marking could designate where a person kneels. In this figure, a person performing exercises would be positioned from the perspective of head to toe along the length of the mat. These placement markings could be used in conjunction with a variety of exercises, such as sit-ups, crunches, leg raises, knee crosses and/or Pilates.

FIG. 3 depicts an example of a placement marking, in accordance with an embodiment of the present invention. The placement marking is to be used to designate the placement of a person's hand and used in conjunction with performing push-up exercises.

FIG. 4 depicts a person performing exercises in conjunction with the exercise mat in accordance with an embodiment of the invention.

FIG. 5 depicts a front view of the exercise mat, in accordance with an alternative embodiment of the invention.

FIG. 6 depicts a back view of the exercise mat, in accordance with an alternative embodiment of the invention.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Indeed, the present invention is in no way limited to the methods and materials described. Exemplary embodiment are illustrated in referenced figures. It is intended that the embodiments and figures disclosed herein are to be considered illustrative rather than restrictive.

As used herein, “push ups” means an exercise for strengthening upper body muscles, performed by lying face down with the palms on the floor, and pushing the body up and down with the arms.

As used herein, “sit ups” means an abdominal exercise, in which one uses the abdominal muscles to raise the torso from a supine to a sitting position and then lies back down again without moving the legs.

As used herein, “crunches” means a modified sit up, having a smaller range of motion that reduces back strain and strengthens the abdominal muscles.

As used herein “cross-knee twisting crunches” means a modified crunch using a cross knee/twisting motion.

As used herein, “twisting legs up crunch” means a modified crunch where the legs are raised in a vertical fashion.

As used herein, “abdominal bicycle” means a modified crunch where one uses a cycle pedal motion with the legs.

As used herein, the terms “horizontal axis” and “vertical axis” describe various spatial arrangements for purposes of illustrating embodiments described herein, with the vertical axis oriented down the center of the mat.

As used herein, a “mat” is a substantially flat cushion-like structure which can be used in conjunction with exercises.

As described herein, the inventor has created an exercise mat that provides markings and notations that can be used as points of reference for exercise positioning and orientation. By creating an improved exercise mat with placement makings, the inventor has created a means of ensuring that various exercises performed on the mat have the proper form.

As further described herein, the inventor has also created an exercise mat containing descriptions and instructions in conjunction with the mat's various markings and notations. In one embodiment, the descriptions and/or instructions appear directly on the mat, thus providing an advantage and convenience to a user performing exercises that utilize the various markings and/or notations that also appear on the mat. Alternatively; the descriptions and/or instructions may be separate from the mat.

In one embodiment, the present invention provides an apparatus for performing exercises properly by providing a series of hand placement markings 100 and/or a torso placement marking 101 on the surface of a mat 102. Optionally, the hand placement markings 100 may include a variety of shapes, forms and sizes, such as circles, squares, triangles, numbers, and/or hand shapes. In another embodiment, the hand placement markings 100 may be have both a large and small size for men, and another size for a female. Optionally, the mat 102 itself may be shaped in various sizes and forms, such as an oval, circle square, rectangle, and/or triangle, and also may be comprised of a variety of materials, such as fabric, cushions, and/or rubber. In another embodiment, the mat 102 contains text of push up instructions 103, with or without hand placement markings 100 on the surface of the mat 102. In another embodiment, the hand placement markings 100 include notations. In another embodiment, the text of push up instructions 103 includes descriptions of push ups for Beginner, Intermediate, Advanced, and Expert levels. In another embodiment, the text of push up instructions 103 appears on a medium separate from the mat 102.

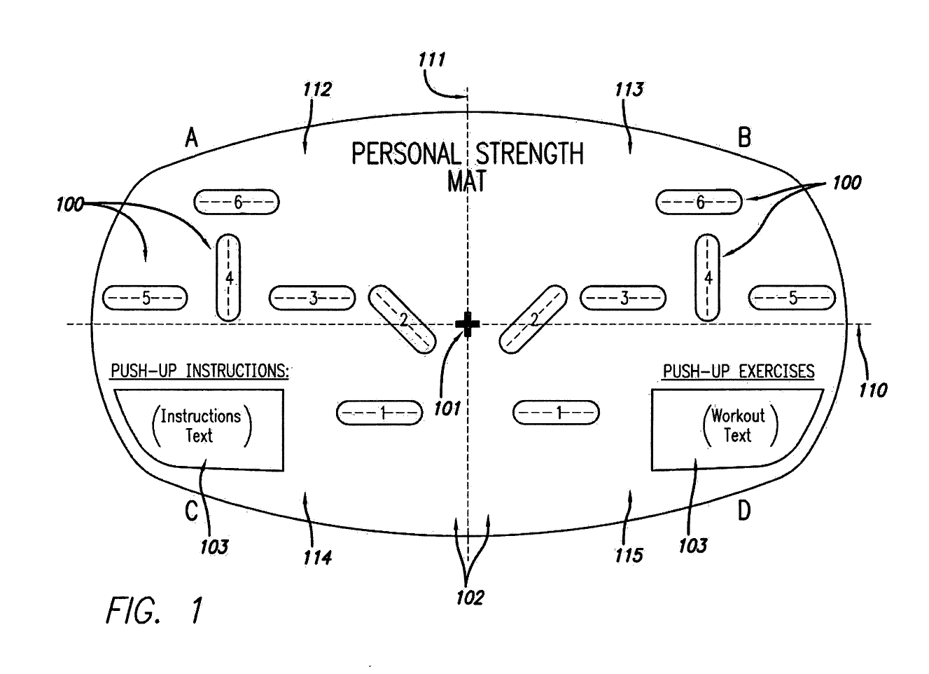

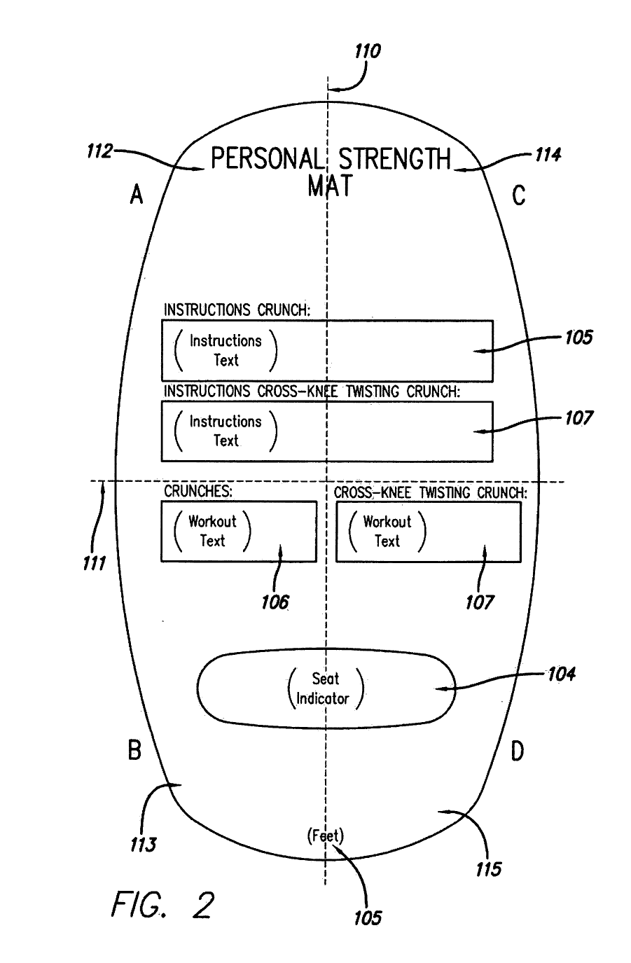

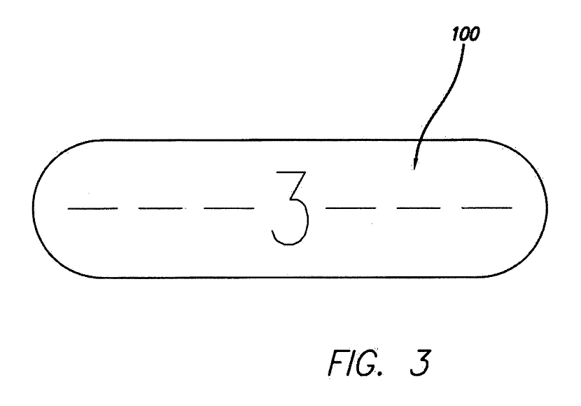

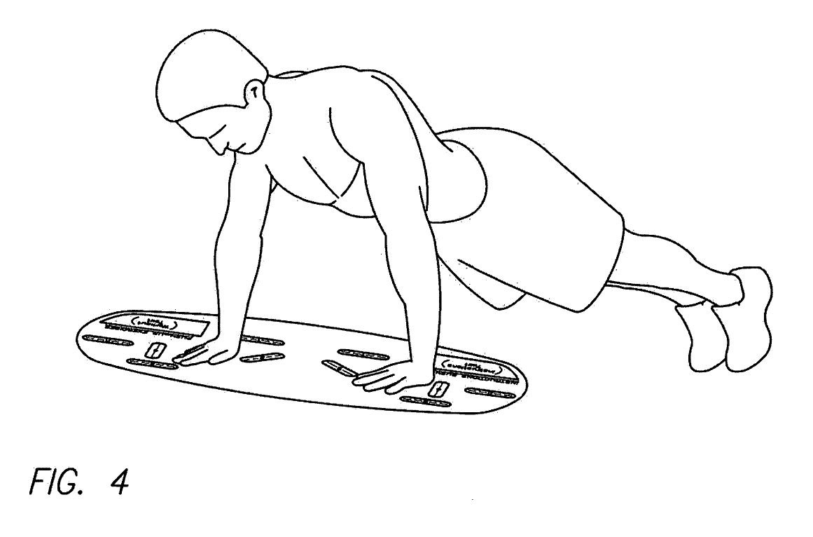

As shown in FIGS. 1-4, one embodiment provides an apparatus with hand placement markings 100 on a front side of the mat 102 and a sitting placement marking 104 and/or foot placement marking 105 on a back side of the mat 102, as a means of providing points of reference for exercises. In another embodiment, the mat 102 has a horizontal axis 110 and a vertical axis 111, which then divide the mat 102 into quadrant A 112, quadrant B 113, quadrant C 114, and quadrant D 115, with the vertical axis 111 oriented down the center of the mat 102. In another embodiment, the front side of the mat 102 may include text of push up instructions 103. In another embodiment, the text of push up instructions 103 is located in quadrant C 114 and/or quadrant D 115. In another embodiment, the back side of the mat 102 may include text of crunch instructions 106 and/or cross-knee instructions 107. In another embodiment, the crunch instructions 106 and cross-knee instructions 107 are on the back side of the mat 102 in quadrant A 112 and quadrant C 114. In another embodiment, the crunch instructions 106 are on the back side of the mat 102 in quadrant B 113 and the cross-knee instructions 107 are on the back side of the mat 102 in quadrant D 115. Optionally, the mat 102 can have dimensions of approximately 48 inches×30 inches. In another embodiment, the hand placement markings 100, sitting placement markings 104, and/or foot placement markings 105 are numeric. In another embodiment, the sitting placement markings 104 on the back side of the mat 102 provide points of reference for sit-ups, crunches, leg raises, knee crosses and/or Pilates exercises.

In one embodiment, the present invention provides a method of performing an exercise by describing physical movements in conjunction with hand placement markings 100 and/or a sitting placement marking 104 on a mat 102. In another embodiment, hand placement markings 100 are numeric. In another embodiment, the exercise includes push-ups, sit-ups, crunches, leg raises and/or Pilates exercises. In another embodiment, the physical movements are described on a medium separate from the mat 102.

In one embodiment, the present invention provides for kits to perform exercises, including but not limited to: a mat 102 with descriptions of exercises, hand placement markings 100 and/or a sitting placement marking 104.

Instructions for use may be included in the kit. “Instructions for use” can be located on the mat 102 itself or separate, and typically include a tangible expression describing the technique to be employed in using the components of the kit to effect a desired outcome, such as how to use the mat 102 to ensure that exercises are performed properly. In one embodiment, the instructions for use reference specific notations and/or markings on the mat, such as hand placement markings, that are to be used in conjunction with the designated exercise. Optionally, the instructions for use can be located in a folded paper, video, DVD, tape recording, or any other medium that would be readily recognized by those of skill in the art, and would reference the use of notations and/or markings that appear on the mat in conjunction with various exercises. Optionally, the kit also contains other useful components such as weights, cushions, or other useful paraphernalia as will be readily recognized by those of skill in the art.

In one embodiment, the present invention provides a method of exercising by performing a series of exercises in conjunction with hand placement markings 100, a sitting placement marking 104, descriptions of exercises, and a mat 102. In another embodiment, the descriptions of exercises are located on the mat 102. In another embodiment, the descriptions of exercises are located separate from the mat 102.

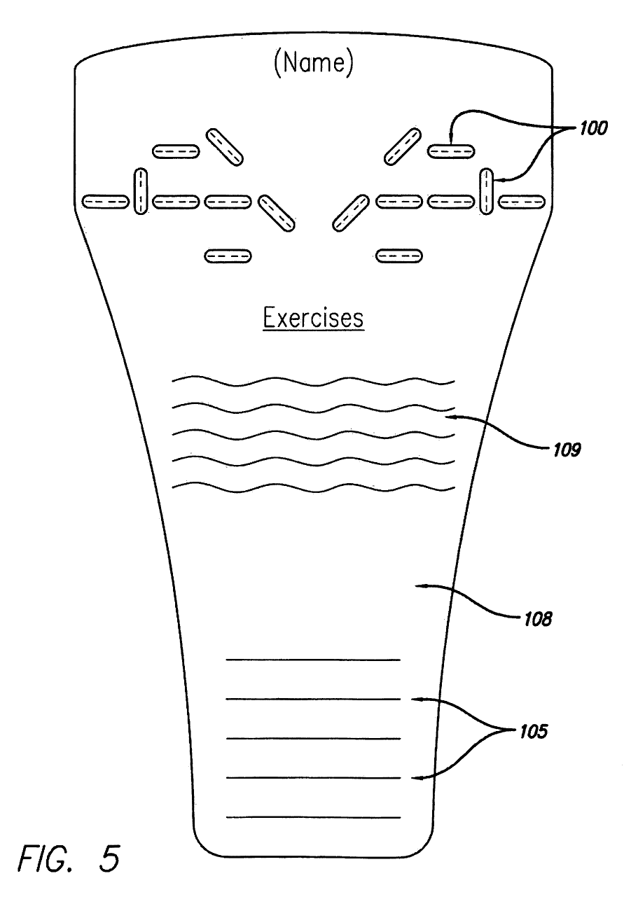

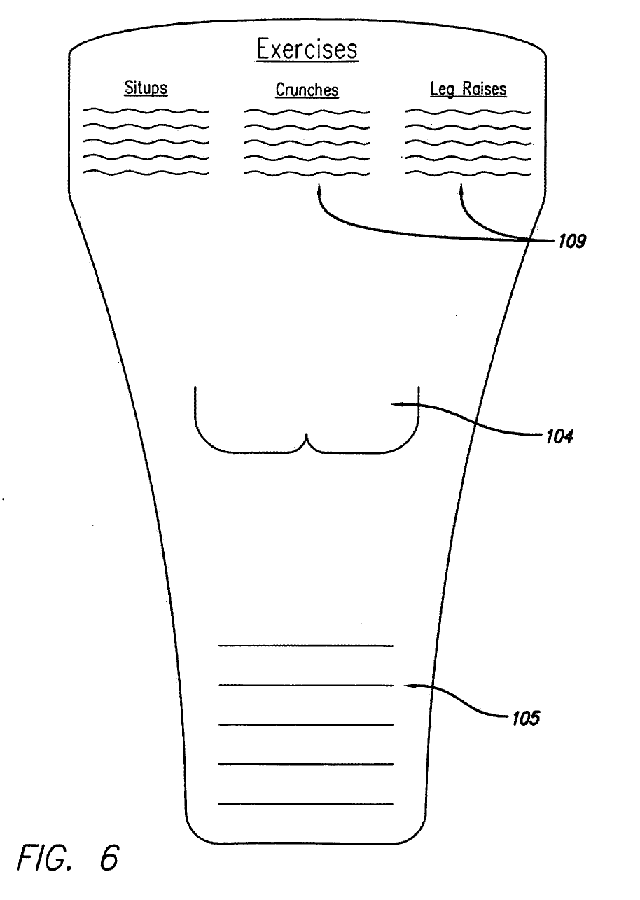

As shown in FIGS. 5-6, one alternative embodiment provides an alternative mat 108 with hand placement markings 100, a foot placement marking 105 and workout instructions 109 on a front side of the mat, and a sitting placement marking 104, a foot placement marking 105, and workout instructions 109 on a back side of the alternative mat 108. Optionally, the apparatus can have dimensions of approximately 4 feet×7 feet×2 feet. In another embodiment, the workout instructions 109 provide descriptions and/or instructions for performing exercises for levels of beginner, intermediate, advanced and/or expert. In another embodiment, hand placement markings 100 on the front side of the alternative mat 108 provide points of reference for push-up exercises. In another embodiment, a sitting placement marking 104 on the back side of the alternative mat 108 provide points of reference for sit-ups, crunches, leg raises, knee crosses and/or Pilates exercises.

### EXAMPLES

The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

### Example 1

### Instructions for Exercise Mat

### Table 1

Table 1. Various instructions for performing exercises may be included as text directly on the Exercise Mat; alternatively, the various instructions for performing exercises may be located separate from the Exercise Mat. The text may be what is described in Table 1, or it may be the equivalent. Furthermore, various numbered marks that appear on the Exercise Mat may be used for a variety of ways as referenced by the instructions. For example, the numbered marks may be used in conjunction with instructions to perform an exercise using the numbered marks chronologically; alternative, the numbered marks may be used to designate exercises performed as “odd numbers,” using “even numbers” for alternative exercises.

| TYPE OF EXERCISE | INSTRUCTION FOR EXERCISE |
|---|---|
| Push Ups | Place hands on matching numbered marks with palm of hand |
| | centered across bar as indicated. Start in the up position with arms |
| | extended and body straight. Center your chest above the “+” |
| | symbol. Perform the push up by slowly lowering the torso to the |
| | mat, and repeat. For Monday, Wednesday and Friday, use the |
| | designated odd numbers. For Tuesday, Thursday and Saturday, use |
| | the designated even numbers. Start at the beginner level and move |
| | up when completing all reps within the set without stopping. |
| | Resting one minute between sets. |
| Push Ups | Beginner level at 3 sets of 5 reps. Intermediate level at 3 sets of 8 |
| | reps. Advanced level at 3 sets of 12 reps. Expert level at 3 sets of |
| | 20 reps plus 1 set of maximum reps. |
| Crunches | Lie on your back with the knees bent, and feet flat on the floor. |
| | Place your hands so that they're lightly touching your head behind |
| | your ears. As you exhale, slowly curl your head and torso toward |
| | your knees until your shoulder blades are off the floor and hold it for |
| | 2 seconds. Inhale as you return to the starting position. Rest one |
| | minute between sets. Perform this exercise Monday, Wednesday |
| | and Fridays. |
| Crunches | Beginner level at 3 sets of 8 reps. Intermediate level as 3 sets of 10 |
| | reps. Advance level at 3 sets of 12 reps. Expert level at 3 sets of 20 |
| | reps plus 1 set of maximum reps. |
| Cross-Knee Twisting | Lie on your back with knees bent, feet flat on floor. Cross your right |
| Crunch | foot over your left knee so your right ankle rests just below your left |
| | knee. Place your left hand so that it's lightly touching your head |
| | behind your ear, right hand resting on your midsection. As you |
| | exhale, slowly curl your head and torso off the floor twisting to the |
| | right bringing your left elbow to your right knee. Hold for 2 |
| | seconds. Inhale as you return to the starting position. Finish the set |
| | and switch opposite positions to work the other side. Resting one |
| | minute between sets. Perform Tuesday, Thursday and Saturday. |
| Cross-Knee Twisting | Beginner level at 3 sets of 8 reps. Intermediate level at 3 sets of 10 |
| Crunches | reps. Advance level at 3 sets of 12 reps. Expert level at 3 sets of 20 |
| | reps plus 1 set of maximum reps. |
| Advanced-Push ups | Elevate feet on an object. Perform all sets with maximum reps. |
| | Perform push ups with hands on an exercise ball. |
| Advanced-Crunches | Place a weight on your chest. Raise feet so thighs are perpendicular |
| | to the floor. |
| Advanced-Twisting | Raise legs so that they are in a “V” shaped configuration. |
| Legs-up Crunches | |
| Advanced-Abdominal | Beginner level of 20 reps. Intermediate level of 30 reps. Advance |
| Bicycles | level of 40 reps. Expert level of 50 reps. |
| Push Ups | Various push-up exercises may be performed using the Exercise |
| | Mat, where push-up exercises are performed on Mondays, Tuesdays |
| | and Wednesdays as part of an overall exercise regimen. For each |
| | day of push-up exercises, one would perform 3 sets of push-up |
| | exercises for each designated push-up position on the Exercise Mat. |
| | Levels of difficulty of the push-up exercises would depend on |
| | whether the person was at the level of Beginner, Intermediate, |
| | Advance or Expert, with 8 repetitions for Beginner, 10 repetitions |
| | for Intermediate, 12 repetitions for Advance, and 20 repetitions for |
| | Expert. |
| Sit Ups | Various sit-up exercises may be performed using the Exercise Mat, |
| | where sit-up exercises are performed on Tuesdays and Thursdays as |
| | part of an overall exercise regimen. For each day of sit-up exercises, |
| | one would perform 3 sets of sit-up exercises for each designated sit- |
| | up position on the Exercise Mat. One who is a Beginner would |
| | perform 8 repetitions, an Intermediate would perform 10 repetitions, |
| | an Advance would perform 12 repetitions, and an Expert would |
| | perform 20 repetitions. |
| Crunches | Various crunches exercises may be performed using the Exercise |
| | Mat, where, with knees bent, crunches exercises are performed on |
| | Tuesdays and Thursdays as part of an overall exercise regimen. For |
| | each day of crunches exercises, one would perform 3 sets of |
| | crunches exercises for each designated crunches position on the |
| | Exercise Mat. One who is a Beginner would perform 8 repetitions, |
| | an Intermediate would perform 10 repetitions, an Advance would |
| | perform 12 repetitions, and an Expert would perform 20 repetitions. |
| Cross-Knee | Various knee crosser exercises may be performed using the Exercise |
| | Mat, where knee crosser exercises are performed on Tuesdays and |
| | Thursdays as part of an overall exercise regimen. For each day of |
| | knee crosser exercises, one would perform 3 sets of knee crosser |
| | exercises, both for each right and left direction and for each |
| | designated knee crosser position on the Exercise Mat. One who is a |
| | Beginner would perform 8 repetitions, an Intermediate would |
| | perform 10 repetitions, an Advance would perform 12 repetitions, |
| | and an Expert would perform 20 repetitions. |

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive.

What is claimed is:

1. An exercise mat, comprising:
a front side; and
a back side,
wherein said front side comprises a plurality of hand placement markings and instructions, and
wherein the instructions describe an exercise selected from the group consisting of push ups, crunches and cross-knee twisting crunches.

2. The exercise mat of claim 1, wherein the back side comprises a sitting placement marking.

3. The exercise mat of claim 1, wherein the back side comprises afoot placement marking.

4. The exercise mat of claim 1, wherein the front side comprises a vertical axis oriented down its center and six pairs of hand placement markings, wherein the vertical axis divides each pair of the six pairs of hand placement markings such that the markings in a pair are on opposite sides of the vertical axis and each marking in a pair is located at an equal distance from the axis.

5. The exercise mat of claim 4, wherein at least one pair of the six pairs of hand placement markings are oval in shape and the longest oval axis is at an angle of 90° in relation to the vertical axis.

6. The exercise mat of claim 5, wherein the front side comprises a torso placement marking.

7. An exercise mat, comprising:
a flat surface having a vertical axis oriented down its center;
a first pair of hand placement markings located at a first position along the vertical axis and separated from one another by a first distance;
a second pair of hand placement markings located at a second position along the vertical axis and separated from one another by a second distance; and
a third pair of hand placement markings at a third position along the vertical axis and separated from one another by a third distance,
wherein the first distance is less than the second distance and the third distance, and the second distance is less than the third distance.

8. The exercise mat of claim 7, wherein the first distance is between 6 and 10 inches.

9. The exercise mat of claim 7, wherein the second distance is between 11 and 17 inches.

10. The exercise mat of claim 7, wherein the third distance is between 18 and 25 inches.

11. The exercise mat of claim 7, wherein the second position is located between the first position and the third position.

12. The exercise mat of claim 11, further comprising a fourth pair of hand placement markings located at a fourth position along the vertical axis and separated from one another by a fourth distance, wherein the fourth distance is less than the first distance, second distance and third distance.

13. The exercise mat of claim 12, wherein the fourth position is located between the first position and the second position.

14. The exercise mat of claim 12, further comprising a fifth pair of hand placement markings located at a fifth position along the vertical axis and separated from one another by a fifth distance, wherein the fifth distance is greater than the first distance, second distance, third distance and fourth distance.

15. The exercise mat of claim 14, further comprising a sixth pair of hand placement markings located at a sixth position long the vertical axis and separated from one another by a sixth distance, wherein the sixth distance is greater than the fifth distance.

16. The exercise mat of claim 7, further comprising instructions for performing exercises selected from the group consisting of push ups, crunches and cross-knee twisting crunches, wherein the instructions appear on the flat surface.

17. A method of utilizing an exercise mat, comprising:
obtaining an exercise-mat comprising:
a flat surface having a vertical axis oriented down its center;
a first pair of hand placement markings located at a first position along the vertical axis and separated from one another by a first distance;
a second pair of hand placement markings located at a second position along the vertical axis and separated from one another by a second distance; and
a third pair of hand placement markings at a third position along the vertical axis and separated from one another by a third distance,
wherein the first distance is less than the second distance and the third distance, and the second distance is less than the third distance; and
utilizing the exercise mat by following an exercise regimen, wherein, in response to instructions, a user places hands on the hand placement markings.

18. The method of claim 17, wherein the exercise regimen is described as text on the exercise mat.
